(19) United States
(12) Patent Application Publication
(10) Pub. No.: US 2008/0261816 A1
(43) Pub. Date: Oct. 23, 2008

(54) ACTIVE AGENT CELLULOSIC CARRIER GRANULE

(75) Inventor: Timothy D. Birthisel, Perrysburg, OH (US)

Correspondence Address: GIFFORD, KRASS, SPRINKLE,ANDERSON & CITKOWSKI, P.C, PO BOX 7021, TROY, MI, 48007-7021, US

(73) Assignee: The Andersons, Inc., Maumee, OH (US)

(21) Appl. No.: 12/108,307

(22) Filed: Apr. 23, 2008

Related U.S. Application Data
(60) Provisional application No. 60/913,389, filed on Apr. 23, 2007.

(51) Int. Cl. A01N 25/26; A01N 43/653; A01N 37/06; A01N 37/00

(52) U.S. Cl. 504/358; 424/490; 514/783; 514/769; 514/383; 514/557; 514/539

(57) ABSTRACT

An inventive flowable granular material for adhesion to foliage is provided, which material includes peanut hull fragments as a preferably majority lightweight component, a heavy weight component mixed therewith to improve the flowability of the resultant granular material, and a solvent to aid in the transfer of the foliar active agent to a leaf surface and foliar adhesion. Related particle size distributions and densities are described. Also provided is a process for promoting plant growth comprising: broadcast distributing the inventive flowable granular material to adhere to foliar surfaces; and releasing the foliar active agent onto the foliar surface.

### REFERENCE TO RELATED APPLICATION

This application claims priority from U.S. Provisional Patent Application Ser. No. 60/913,389, filed Apr. 23, 2007, the entire content of which is incorporated herein by reference.

### FIELD OF THE INVENTION

The present invention, in general, relates to an active agent carrier granule and, in particular, to a granule including a majority by weight percent peanut hull screened fragments and a higher density mineral component blended to adjust granule density to a predetermined value.

### BACKGROUND OF THE INVENTION

In order to limit plant damage associated with a pest infestation, it is frequently desirable to transfer an active agent from a carrier granule to a target leaf surface. Representative of such foliar active agents are pesticides targeting leaf-borne pests. Traditionally, the application of a foliar active agent required access to a water supply in proximity to the plant target to premix an active agent in a spray tank and followed by spray application from the spray tanks. Unfortunately, spray tanks are prone to spills that are difficult to contain and due to spray freeze, cannot be applied under freezing conditions. Additionally, an aerosol spray is subject to drift, thereby exposing non-target organisms to the foliar active agent. As a result of aerosol drift, spray application is precluded by windy conditions.

In light of the difficulties associated with applying foliar active agents adhesive to foliage as a spray, there exists a need for a granular form of foliar active agent application so as to extend the conditions under which application may occur and limit incidental environmental exposure.

### SUMMARY OF THE INVENTION

Provided by the invention is a flowable granular material for adhesion to foliage comprising: a plurality of peanut hull particles having a hull size distribution which 85 weight percent of the plurality of peanut hull particles are sized between US 16 mesh and US 40 mesh; a plurality of high density material particles having a density of between 62 and 120 lbs. per cubic foot and a size distribution in which 80 weight percent of the plurality of high-density material particles are sized between US 16 mesh and US 40 mesh; a foliar active agent coating the plurality of peanut hull particles and the plurality of high-density material particles; and a foliage compatible solvent coating the plurality of peanut hull particles and the plurality of high density material particles.

In one embodiment of the invention, the plurality of peanut hull particles are present at 50 to 95 total weight percent.

In another embodiment, the plurality of peanut hull particles are agglomerated fine particles held together with a peanut hull particulate binder.

In another embodiment, the plurality of high-density material particles are present from 5 to 50 total weight percent.

In another embodiment, the plurality of high-density material particles are agglomerated small particles held together with a high-density material binder.

In another embodiment, the plurality of high-density material particles are found of a material selected from the group consisting of: limestone, gypsum, sand, ammonium sulfate, and combinations thereof.

In another embodiment, the foliar active agent is present from 0.001 to 5 total weight percent.

In another embodiment, the foliar active agent is selected from the group consisting of: propiconazol, trinexapac ethyl, azovstrobin, trifloxystrobin.

In another embodiment, the solvent is present from 0.01 to 10 total weight percent.

In another embodiment, the flowable granular material of the invention further comprises a surfactant to facilitate the solvent and the foliar active agent coating the plurality of peanut hull particles and the plurality of high-density material particles.

In another embodiment, the flowable granular material of the invention further comprises a second foliar active agent coating the plurality of peanut hull particles and the plurality of high-density material particles.

Also provided by the invention is a process for promoting plant growth comprising: broadcast distributing the flowable granular material of the invention to adhere to foliar surfaces; and releasing said foliar active agent onto the foliar surface.

### DETAILED DESCRIPTION OF THE INVENTION

The present invention has utility as a granular material adherent to foliage inclusive of a foliar active agent. The granular material includes peanut hull fragments as a preferably majority lightweight component. A heavy weight component is mixed therewith to improve the flowability of the resultant granular material. Additionally, a solvent is present to aid in the transfer of the foliar active agent to a leaf surface and foliar adhesion.

A foliar active agent is effective when in contact with a leaf surface and must effectively be transferred from the inventive granular material to the leaf surface. The foliar active agent is present at between 0.001 and 5 total weight percent of the granular material. A foliar active agent is added virtually without limit and includes any foliar active agent active to inhibit an organism deleterious to the target plant and includes herbicide, insecticide, fungicide, nematicide, pesticide, or a plant growth regulator, or other biologically active agent or pesticide.

Representative herbicide active agents illustratively include dintroanilines such as benefin, trifluralin, pendimethalin, and prodiamine; oxadiazoles such as oxadiazon; triazines such as atrazine and simazine; triazolinones such as carfentrazone and sulfentrazone; aryloxyphenoxy propionates; arylaminopropionic acid; cineole (such as cinmethylin); cyclohexanediones; sulfonylureas such as trifloxysulfuron and metsulfuron-methyl; imidazolinones; pyrimidinylthio-benzoate; triazolopyrimidine; pyridazine; phenoxys (or phenoxies); benzoic acids; carboxylic acids (such as DCPA (dimethyl tetrachloroterephthalate), clopyralid, trichloroacetic acid, and flouroxypyr); quinoline carboxylic acid; semicarbazone; triazinones; uracils; pyridazinone; phenyl-carbamates; nitriles; benzothiadiazoles; organoarsenicals; phenyl-pyridazine; triketones such as mesotrione; ureas and substituted ureas (such as diuron, linuron, siduron, tebuthiuron, dymron etc.); amide (such as propanil and bromobutide); thiocarbamates; pyrazolium (such as difenzoquat); phosphoric acid compounds (such as glufosinate-ammonium and glyphosate); triazole (e.g. propiconazol); pyridazinone; nicotinanilide; pyridinone (such as fluridone); isoxazolidinone; diphenylethers; N-phenylphthalimides; oxadiazole; triazolinone; chloroacetamides; oxyacetamides; phthalamate; phthalamate semicarbazone; nitrile; N-phenylphthalimides; oxadiazole; triazolinone; acetamides; benzoylisoxazole; isoxazole; pyrazole; pyrazolium; triketone; and benzofuran; various ALS (acetolactate synthase) inhibitors; and plant extract herbicides such as the allelopathic exudates of various plants.

Representative microbiocidal and fungicidal active agents illustratively include plant and general disease control agents including fungicides, fungistats, antibiotics and bacteriocides of the following chemical families and functional groupings; various acetamides; sterol inhibitors or demethylase inhibitors; dicarboximides (such as iprodione); phthalides; phthalmic acids; triadiazoles; isophthalates, triazines; triconazoles; strobilurins; Stobin (e.g., azovstrobin, trifloxystrobin); benzimidazoles; benzithiazoles; dithiocarbamates; carboxamides; carboxides; anilides; chlorphenyls; indolecarboxylic acids; isoxazoles; imidazoles; oxazolinediones; guanidines; diguanidines; piperidines; pyridines; sulfenamides; sulfonamides; quinolines; cyanoimidazoles; pyrazoles; pyrrolecarbonitriles; spiroketalamines; thiazoles; various chemical families of oomycete (pythium) fungicides; nitriles; chlorinated hydrocarbons; phenylpyrroles; polyoxins; pyridazinones; mycotoxins (e.g. penicillin) or other antibiotics (e.g. streptomycin, kasugamycin, blasticidin, polyoxins, validamycin, mildiomycin, and oxytetracyline); morpholines; other organic compounds such as piperalin, piperazine derivatives and tolylfluanid, bronopol, organic compound mixtures (e.g. bacticin and harpin protein), organic acids such as trinexapac ethyl, cinnamic acid and its derivatives, bacteria such as Agrobacterium radiobacter, Bacillus subtilus, Erwinia carotovora, Pseudomonas flourescens and P. chlorophis, and any varieties or strains thereof, fungi such as Candida oleophila, Fusarium, Tricoderma, Gliocladium, Streptomyces, and Ampelomyces and any species, varieties or strains thereof, and viruses such as tomovax.

For purposes of this invention, plant growth regulators are ingredients such as trinexepac-ethyl, gibberellic acid, gibberellins, cytokinins, benzyladenine, glycines, quinolenes, phosphoric acid compounds, organic carbamates, quaternary ammonium compounds, acetamides, ethychlozate, azoles, paclobutrazol, anilides, pyradazidine, pyrimidines, napthaleneacetamide, phthalmides, phenoxies, pyrimidines, hybridizing agent, biostimulants, seaweed extracts and herbicides (typically at low use rates), phthalmides, phenoxies, and organic or carboxylic acids (e.g, gamma amino butyric acid and L-glutamic acid, naphthalene acetic acid, clofencoet, sintofen, nicotinic acids).

For purposes of this invention, other pesticides include animal and bird repellants, bitter flavors, irritants, and malodorous ingredients, molluscicides (e.g., slugs and snails), nematicides, rodenticides, defoliants, chemosterilants, plant defense boosters (harpin protein and chitosan) desiccants (may also be used as a harvest aid), and other beneficial or detrimental agents applied to plant or other surfaces.

Pesticides suitable to form a liquid coating on an active agent carrier particle include pyrethroids such as bifenthrin, permethrin, deltamethrin, lambda cyhalothrin, cyfluthrin, or betacyfluthrin; organophosphates such as chlorpyrifos; limonoids such as azadirachtin or meliartenin; phenyl pyrazoles or oxadiazines such as indoxacarb; phthallic acid diamides such as flubendiamide and anthranilic diamides. Additionally, it is appreciated that a number of conventional adjuvant systems used to solubilize a pesticide for application as a coating onto an active agent carrier particle are rendered more effective by the present invention. By way of example, pyrethroids degrade to yield organic acids that in proximity to certain pesticide powders such as carbamates function to extend the carbamate activity half-life.

For purposes of this invention, other protectants and beneficial ingredients include attractants, baits, herbicide safeners, antidessicants, antitranspirants, frost prevention aids, inoculants, dyes, brighteners, markers, synergists, pigments, UV protectants, antioxidants, leaf polish, pigmentation stimulants and inhibitors, surfactants, moisture retention aids, molluscicides (e.g., slugs and snails), nematicides, rodenticides, defoliants, desiccants, sticky traps, and IPM lures.

It is appreciated that multiple active agents are readily formulated within an active agent granule. Active agent granules are optionally compounded with inner fillers, dust control and flow aids, solvents, surfactants, and/or other adjuvants, alone or in combination with up to several other active agents.

Peanut hull fragments may be milled to a particle size. Depending upon moisture content and normal variation in peanut hull feed stock, the density of the peanut hull fragments after processing is typically between 20 and 35 lbs. per cubic foot. Alternatively, peanut hull fragments may be pelletized after or without initial milling to produce a more uniform density of 20-30 lbs per cubic foot, and to impart a less fibrous, flaky morphology as an aid to flowability prior to final milling and screening to size (reground pellet granulation). Resultant peanut hull fragments typically constitute between 5 and 99 total weight percent of the granular material; and preferably, between 50 and 95 total weight percent of the granular material.

A peanut hull fragment size is Size Guide Number (SUN) 60-90, and chosen such that 85% by weight of the fragments are between US 16 mesh and US 40 mesh in size, and up to 65% retained on a US 20 mesh screen. It is appreciated that the finer grind fragments are agglomerated with water or steam used as a pellet mill die lubricant and binder aid to achieve a peanut hull fragment size distribution of said 85% by weight of the fragments or agglomerated particles thereof fall between US 16 mesh and US 40 mesh.

A heavy weight material is intermixed with the peanut hull fragments to improve flowability and also adjust the overall density of the resulting granular material. A heavy weight ingredient operative herein is characterized by a density of between 28 and 120 lbs. per cubic foot and a particle size distribution such that 80 percent or more of the heavy weight material particles are between US 16 mesh and US 40 mesh. The heavy weight material is typically present from 5 to 50 total weight percent of the inventive granular material; and preferably, between 20 to 50 total weight percent of the granular material. The high density material operative herein illustratively includes particulate of limestone, gypsum, sand, ammonium sulfate, cement regrind, and combinations thereof.

As with peanut hull agglomerates, heavy weight material fines are also optimally agglomerated to form heavy weight particles with a particle size distribution such that 80 percent or more of the heavy weight material particles are between US 16 mesh and US 40 mesh, or up to SGN 100 size, where 85 percent or more of the particles are between US 16 mesh and US 40 mesh, with up to 100% retained on a US 20 mesh screen. The binder component present in the heavy weight fines is from 0 to 50 weight percent of the heavy weight material and of an identity not material to this invention. For the purposes of the invention, the described U.S. mesh sizes are determined according to the sieve test method specified in ASTM C136-06, the sieves certified according to ASTM standard E11-04; ASTM International, West Conshohocken, Pa.

The inventive granular material includes a solvent present from 0.1 to 10 total weight percent of the granular material and is provided to aid in the transfer of the foliar active agent to the leaf surface and adhese granules of the inventive granular material to a leaf surface. It is noted that the solvent is provided in a quantity sufficient to facilitate foliar active agent transfer to the leaf surface and adhesion of a granular particle if the tack is such that the inventive granular material is nonetheless flowable as a particle mass.

The term “flowable” is used herein as defined as a repose angle of less than about 35 degrees as measured by International Standard 8398 of the International Organization of Standardization, or equivalent.

An inventive granular material is optionally formed compounded with a surfactant to facilitate solvent and therefore a foliar active agent wetting of peanut hull particulate and high density material particulate. The surfactant being cationic, anionic, or non-ionic with the choice of a surfactant being dictated by specific identity of the solvent and high density material. A surfactant, if present, is present from 0.01 to 10 total weight percent of the inventive granular material and preferably, from 0.1 to 1 total weight percent.

While the present invention is detailed with respect to a single foliar active agent, it is appreciated that a combination of two or more foliar active agents are readily delivered as a foliar adhesive granular material. While a second foliar active agent is virtually without limit, preferably the second, and still other foliar active agents are chosen to achieve a synergistic action in controlling an organism interfering with the growth of a target plant. In one embodiment of the present invention, the synergy is achieved by the combination of the first and the second foliar active agents.

The present invention is further detailed with respect to the following non-limiting examples. These examples are intended to be exemplary of specific embodiments of the present invention and not limit the scope of the appended claims.

### EXAMPLE 1

25 lbs, of peanut hull particulate having 85 percent by weight particulate retained between US 16 mesh and US 40 mesh screens is combined with 30 lbs. of pelletized limestone with 82 percent by weight of pelletized limestone particulate being retained between US 16 mesh and US 40 mesh screens. Peanut hull particulate and high density material particulate is air mixed to a homogeneous mixture. 3.8 lbs. gamma-butyrolactone is add to a tared beaker and 0.5 lbs. of trifloxystrobin is added with mechanical stirring to obtain a uniform solution. The solution is poured into a tumbling drum containing the peanut hull particulate and high density material particulate to uniformly coat the particulate with the solution. The resulting granular material is flowable with a mild tack capable of adhesing a particle with the granular material on a non-horizontal surface.

### EXAMPLE 2

The granular material of Example 1 is produced with replacement of the pelletized limestone with a carrier particle formed with a combination of a binder component, as disclosed in U.S. Pat. No. 6,884,756. A comparable inventive granular material results.

### EXAMPLE 3

Any patents or publications mentioned in this specification are incorporated herein by reference to the same extent as if each individual publication is specifically and individually indicated to be incorporated by reference.

The processes and apparatus described herein are presently representative of preferred embodiments, exemplary, and not intended as limitations on the scope of the invention. Changes therein and other uses will occur to those skilled in the art. Such changes and other uses can be made without departing from the scope of the invention as set forth in the claims.

1. A flowable granular material for adhesion to foliage comprising:
a plurality of peanut hull particles having a hull size distribution wherein 85 weight percent of said plurality of peanut hull particles are sized between US 16 mesh and US 40 mesh;
a plurality of high density material particles having a density of between 62 and 120 lbs. per cubic foot and a
size distribution in which 80 weight percent of said plurality of high-density material particles are sized between US 16 mesh and US 40 mesh;
a foliar active agent coating said plurality of peanut hull particles and said plurality of high-density material particles; and
a foliage compatible solvent coating said plurality of peanut hull particles and said plurality of high density material particles.

2. The material of claim 1, wherein said plurality of peanut hull particles are present at 50 to 95 total weight percent.

3. The material of claim 1, wherein said plurality of peanut hull particles are agglomerated fine particles held together with a peanut hull particulate binder.

4. The material of claim 1, wherein said plurality of high-density material particles are present from 5 to 50 total weight percent.

5. The material of claim 1, wherein said plurality of high-density material particles are agglomerated small particles held together with a high-density material binder.

6. The material of claim 1, wherein said plurality of high-density material particles are found of a material selected from the group consisting of: limestone, gypsum, sand, ammonium sulfate, and combinations thereof.

7. The material of claim 1, wherein a said foliar active agent is present from 0.001 to 5 total weight percent.

8. The material of claim 1, wherein said foliar active agent is selected from the group consisting of: propiconazol, trinexapac ethyl, azovstrobin, trifloxystrobin.

9. The material of claim 1, wherein said solvent is present from 0.01 to 10 total weight percent.

10. The material of claim 1, further comprising a surfactant to facilitate said solvent and said foliar active agent coating said plurality of peanut hull particles and said plurality of high-density material particles.

11. The material of claim 1, further comprising a second foliar active agent coating said plurality of peanut hull particles and said plurality of high-density material particles.

12. A process for promoting plant growth comprising:
broadcast distributing the flowable granular material of claim 1 to adhere to foliar surfaces; and
releasing said foliar active agent onto the foliar surface.
